(19) United States
(12) Patent Application Publication
(10) Pub. No.: US 2019/0224703 A1
(43) Pub. Date: Jul. 25, 2019

(54) POWER SPRAYER

(71) Applicant: WESSOL, LLC, Fort Mill, SC (US)

(72) Inventors: Joseph J. Gustafson, Charlotte, NC (US); Steve Norris, Mainville, OH (US)

(21) Appl. No.: 16/253,702

(22) Filed: Jan. 22, 2019

Related U.S. Application Data
(63) Continuation-in-part of application No. 16/143,721, filed on Sep. 27, 2018.
(60) Provisional application No. 62/689,447, filed on Jun. 25, 2018.
(60) Provisional application No. 62/620,262, filed on Jan. 22, 2018.

(51) Int. Cl. B05B 9/08; B05B 15/00

(52) U.S. Cl. CPC B05B 9/0861; B05B 15/00; B05B 9/0888

(57) ABSTRACT

A power sprayer that includes a housing on which is mounted a battery, a battery-powered motor and a motor-powered liquid pump and a tank communicating with the pump for holding a supply of water or other liquid. An outlet from the pump to a connector is provided and adapted to receive a hose. An applicator wand is provided for connection to the hose for directing fluid under pressure to a desired target.

### CROSS REFERENCE TO RELATED PATENT APPLICATIONS

This application claims the benefit of and priority to U.S. Non Provisional patent application Ser. No. 16/143,721, filed on Sep. 27, 2018 which claims the benefit of and priority to U.S. Provisional Patent Application No. 62/689,447, filed Jun. 25, 2018 This application also claims the benefit of and priority to U.S. Provisional Patent Application No. 62/620,262, filed Jan. 22, 2018, herein expressly incorporated by reference in its entirety.

### TECHNICAL FIELD AND BACKGROUND OF THE INVENTION

This invention relates to a power sprayer that includes a variable pressure control and other features that enable it to be used effectively in high-dust areas, such as when concrete is being sawn.

Many saws produce a large amount of small particulates that are released into the air. These particulates cause safety concerns and have the potential to run afoul of safety regulations. This is especially true for masonry saws when used on concrete or other stone-like materials.

Many masonry saws being sold are beginning to include hose fittings that enable users to attach hoses to the saws. In light of the safety concerns and regulations, such as OSHA regulations, there are several widely available solutions that allow a user to spray water onto or near to the saw blade. One prior art system requires two individuals, one to operate the saw and one to spray water. This system is not efficient due to the delayed application of spray to the location of the cut which enables particulates from the material cut to enter the air. Other prior art systems include a water supply to the saw itself but have other impractical and inefficient draw backs. One such system includes a pump attachment that requires manual pumping to produce a spray of liquid. Manual pumping is difficult, if not impossible, to perform at the same time as operating the saw and therefore requires that a user manually pump then cut and repeat the process over and over until the desired cutting is completed. Another system has a pressurized tank that supplies a spray to the saw. While this system is an improvement over the manual pumping systems, pressurized tanks of liquid add both cost and increase safety considerations of a pressurized vessel in close proximity to a saw.

There is a need for a safe, reliable, and efficient system for spraying liquid at the intersection of the saw blade and the material being sawn.

### SUMMARY OF THE INVENTION

It is therefore an object of the present invention to provide a power sprayer that is adaptable to use with a saw to reduce particulate matter from being released into the air by the saw during use.

It is another object of the invention to provide a power sprayer that is adapted for use as a backpack device to be carried by the user on the back.

It is another object of the invention to provide a power sprayer that has a battery powered pump.

These and other objects and advantages of the present invention are achieved in the preferred embodiments set forth below by providing a power sprayer for use with a saw having a housing on which is mounted a battery connector for receiving a battery, a battery-operated motor operatively connected to the battery connector, and a motor-operated liquid pump operatively connected to the motor. A tank is mounted on the housing for holding a supply of liquid and operatively connected to the pump. The pump has a liquid outlet connected to a conduit for conveying liquid under pressure from the pump to a location proximate to a blade of the saw.

According to another embodiment of the invention, a pair of shoulder straps are connected to the housing for enabling a user to wear the housing with the shoulder straps supporting the housing on the user's back.

According to another embodiment of the invention, a trolley is provided having a handle and at least two wheels adapted for receiving the housing for transport.

According to another embodiment of the invention, the conduit is a flexible hose.

According to another embodiment of the invention, the conduit has a nozzle on a distal end of the conduit for directing the liquid to the location proximate to the blade of the saw.

According to another embodiment of the invention, the nozzle produces a predetermined liquid spray pattern.

According to another embodiment of the invention, the conduit has a connector on a distal end of the conduit for connecting to a corresponding connector located on the saw.

According to another embodiment of the invention, the connector is a brass GHT fitting.

According to another embodiment of the invention, a method of reducing the quantity of particulate matter released into the air by operation of a saw includes the steps of first providing a housing on which is mounted a battery connector for receiving a battery, a battery-operated motor operatively connected to the battery connector, a motor-operated liquid pump operatively connected to the motor, a tank for holding a supply of liquid and operatively connected to the pump, and a liquid outlet from the pump connected to a conduit for conveying liquid under pressure from the pump to a location proximate to a blade of the saw. Then filling the tank with liquid, positioning a distal end of the conduit proximate to the saw blade and operating the pump to direct liquid at an intersection of the saw blade and a material being sawn to capture the small particulate matter released by the saw blade and prevent the particulate matter from entering the air during operation of the saw.

According to one embodiment of the invention, a power sprayer is provided that includes a housing on which is mounted a battery, a battery-powered motor and a motor-powered liquid pump and a tank communicating with the pump for holding a supply of water or other liquid. An outlet from the pump to a connector is provided and adapted to receive a hose. An applicator wand is provided for connection to the hose for directing fluid under pressure to a desired target. The sprayer may be mounted on a backpack device with straps, or mounted to a trolley for rolling the sprayer to locations as needed.

### BRIEF DESCRIPTION OF THE DRAWING FIGURES

The present invention is best understood when the following detailed description of the invention is read with reference to the accompanying drawings, in which:

FIG. 1 is an environmental perspective view of a power sprayer connected to a masonry saw in use according to an embodiment of the invention;

FIG. 2 is an exploded perspective view of the sprayer of FIG. 1;

FIG. 3 is a right side cross-sectional elevation of the sprayer of FIG. 1;

FIG. 4 is a front elevation of the sprayer of FIG. 1;

FIG. 5 is a front elevation of the sprayer of FIG. 1 with the cover removed; and

FIG. 6 is a perspective view of a trolley according to the invention on which the sprayer of FIG. 1 can be mounted for storage and transport during use.

### DETAILED DESCRIPTION OF THE PREFERRED EMBODIMENT

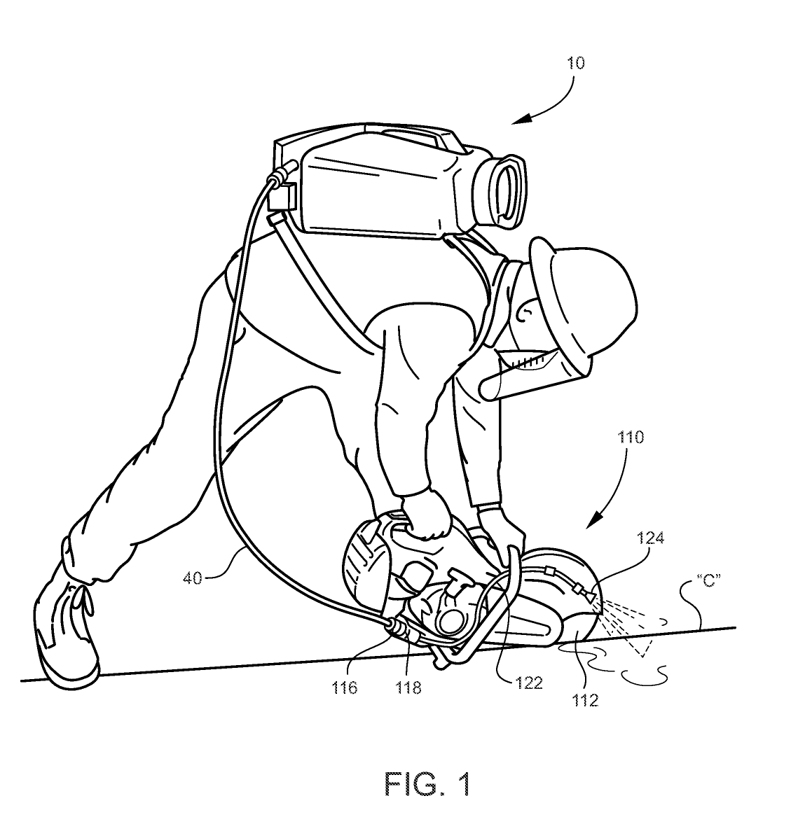

Referring now to the drawings, FIG. 1 shows a power sprayer 10 carried on the back of a user during operation of a saw 110. The sprayer 10 has a discharge hose 40 with an outlet fitting 116 that connects to a saw fitting 118 located on the saw 110. The user is able to open an optional valve (not shown) located downstream from the saw fitting 118 in order to allow liquid, such as water, to continuously flow through a saw conduit 122 and out through a nozzle 124 while cutting. The nozzle 124 is mounted proximate to a saw blade 112. Placement of the nozzle 124 allows the liquid to be sprayed within the region of the cut being made in, for example, concrete “C” by the saw blade 112 and minimize the amount of small particulates from entering the air. The nozzle 124 can have a variety of spray patterns to optimize the application of liquid to the area being sawn.

While FIG. 1 shows a masonry saw 110 connected to the sprayer 10, other types of saws are envisioned for use with the sprayer 10. Examples include, but are not limited to, concrete saws, circular saws, jigsaws, chainsaws, reciprocating saws, band saws, and table saws. Additionally, the sprayer 10 can also be applied to other specialized machinery that are capable of cutting into material such as drills, lathes, and milling machines. The material being cut is also not limited to concrete shown in FIG. 1, but includes other materials such as other stone-like materials, wood, metal, composites, and many other types of materials that produce small particulates capable of entering the air.

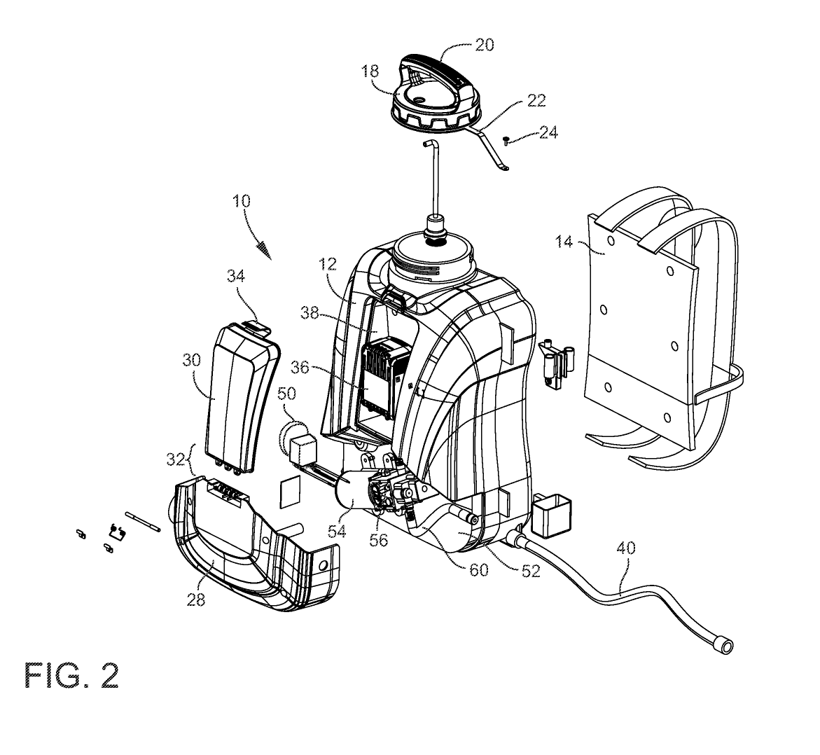

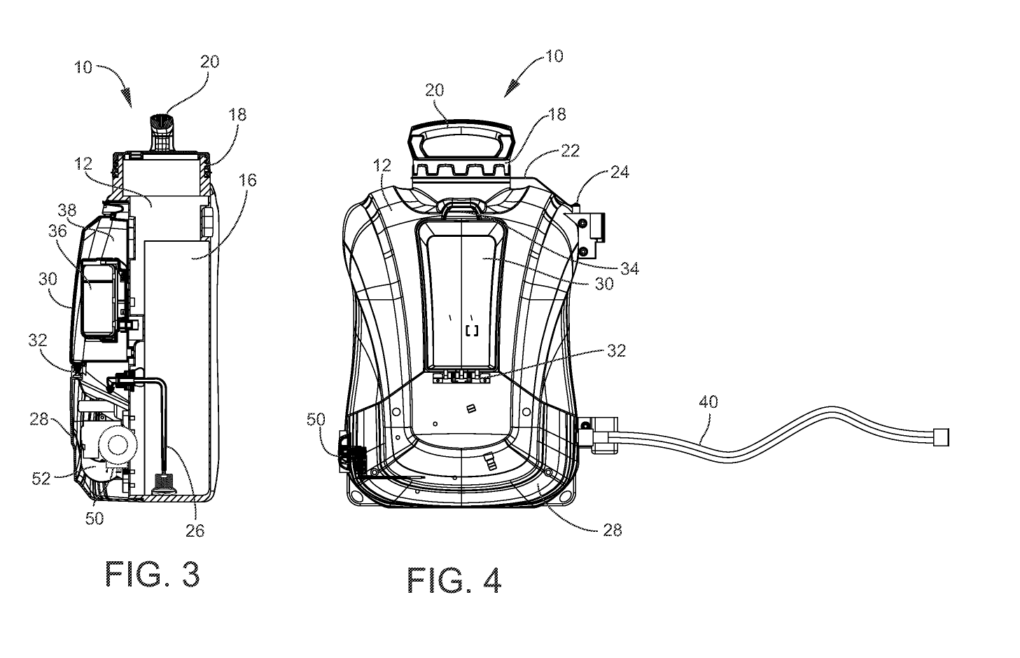

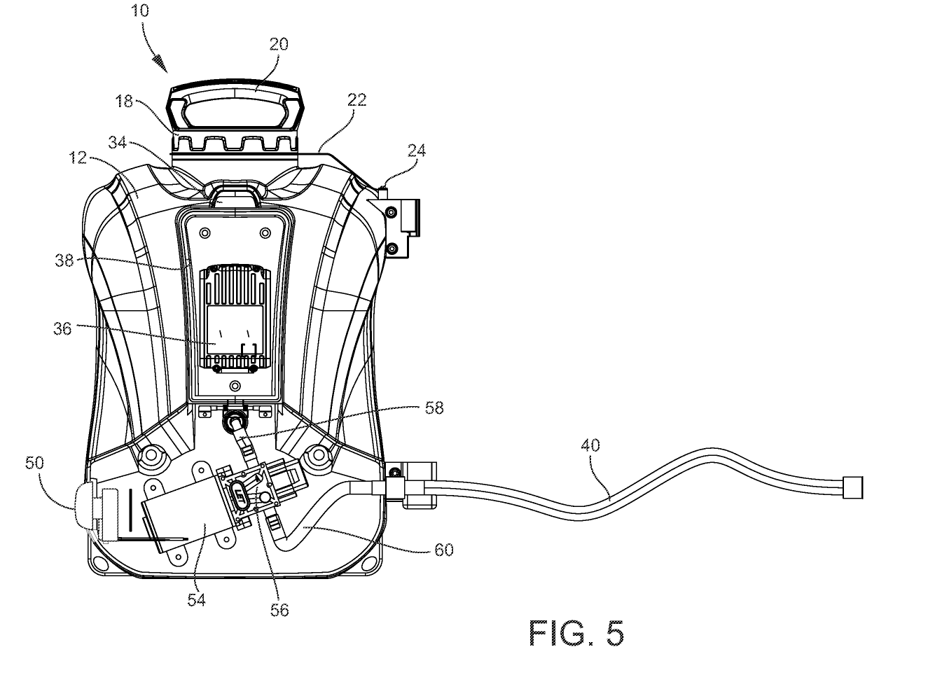

As shown in FIGS. 2-5, the sprayer 10 includes a housing 12 that encloses the operating elements of the sprayer 10. The sprayer 10 may be carried on the back of the user by a shoulder strap assembly 14 that is mounted to the back of the housing 12 by screws, not shown. The housing 12 encloses a tank 16, best shown in FIG. 3. The tank is accessed through a threaded cap 18 that incorporates a carry handle 20. The cap 18 is maintained in proximity to the housing 12 by a short strap 22 attached to the housing 12 by a screw or rivet 24. The interior of the tank 16 includes a siphon 26 that transfers liquid to the operating elements of the sprayer 10, described below.

The housing 12 includes a lower base cover 28 to which is mounted a battery access door 30 mounted for pivoting movement by a hinge assembly 32, and which releasably latches to the housing 12 by a latch release 34. A battery 36, such as a lithium ion battery, is mounted in a battery housing 38 of the housing 12. Liquid under pressure is dispensed from the sprayer 10 through the discharge hose 40.

A variable pressure controller 50 is, optionally, mounted externally to the side of the housing 12 and communicates with a controller housing 52 in the lower part of the housing 12.

The battery 36 supplies nominal 12 V current to a motor 54 that drives a pump 56. The pump 56 draws liquid from the tank 16 through a pump input conduit 58, pressurizes the liquid and discharges it into an output conduit 60 that is connected through the sidewall of the housing 12 to the discharge hose 40.

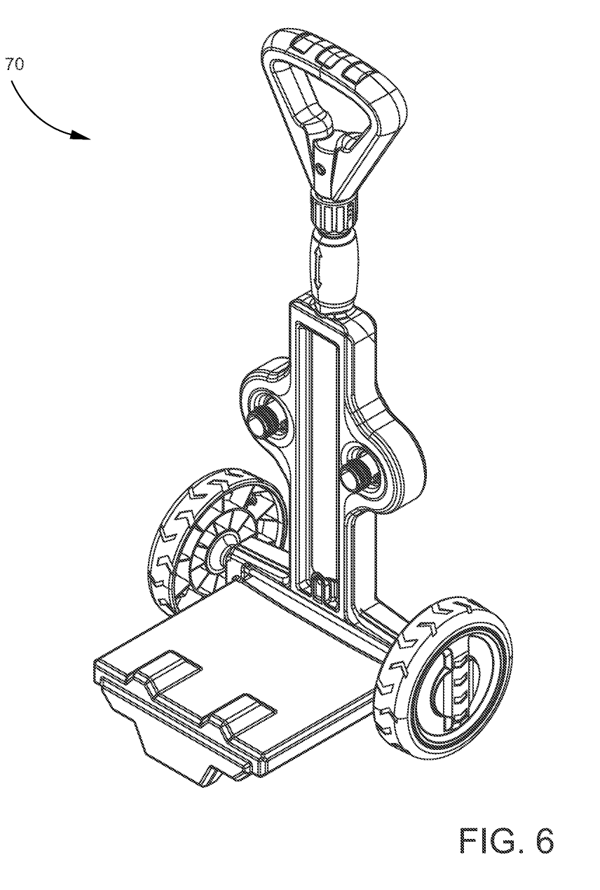

FIG. 6 shows a trolley 70 onto which the sprayer 10 can be mounted. The trolley 70 can be used for carrying the sprayer 10 during operation of the saw 110 in lieu of the user carrying the sprayer 10 on their back. The sprayer 10 can also be placed directly on the ground within conduit 40 range of the user operating the saw 110.

The conduit 40 is typically a flexible hose with a GHT/GHT type that is removable on each end and can connect to the saw 110. Other conduits 40 such as PVC, brass, or metal tubing can also be utilized in situations where the sprayer 10 is placed within range of the user during operation of the saw 110. In this circumstance the conduit 40 could have a swivel, elbow, hinge, or some other type of feature that enables the conduit 40 to connect to the saw 110. The conduit 40 could also be in multiple parts of multiple different types described above.

Typical operating values include:

| Tank capacity | 2.5 Gal/5 liters | | |
|---|---|---|---|
| Working pressure | Low Speed | 45 | psi |
| | High Speed | 60 | psi |
| Battery | LG, 18 V/2.6 AH | | |
| Charger | 21 V/1 A | | |
| Charge Time | 2.5 hours | | |
| Continuing Working | Low Speed | >140 | minutes |
| Time | High Speed | >110 | minutes |
| Flow Rate | Low Speed | 0.33 | Gal/min |
| | High Speed | .040 | Gal/min |
| Liquid output/charge | Low Speed | >45 | Gal |
| | High Speed | >45 | Gal |

| | |
|---|---|
| Spray distance | Variable 25-30 ft, 8 m. |

These values are provided by way of example only. Other values may be suitable.

A power sprayer according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

We claim:

1. A power sprayer for use with a saw comprising:
(a) a housing on which is mounted a battery connector for receiving a battery, a battery-operated motor operatively connected to the battery connector, and a motor-operated liquid pump operatively connected to the motor;
(b) a tank mounted on the housing for holding a supply of liquid and operatively connected to the pump; and
(c) the pump having a liquid outlet connected to a conduit for conveying liquid under pressure from the pump to a location proximate to a blade of the saw.

2. A power sprayer according to claim 1, further comprising a pair of shoulder straps connected to the housing for enabling a user to wear the housing with the shoulder straps supporting the housing on the user's back.

3. A power sprayer according to claim 1, further comprising a trolley having a handle and at least two wheels adapted for receiving the housing for transport.

4. A power sprayer according to claim 1, wherein the conduit is a flexible hose.

5. A power sprayer according to claim 1, wherein the conduit has a nozzle on a distal end of the conduit for directing the liquid to the location proximate to the blade of the saw.

6. A power sprayer according to claim 5, wherein the nozzle produces a predetermined liquid spray pattern.

7. A power sprayer according to claim 1, wherein the conduit has a connector on a distal end of the conduit for connecting to a corresponding connector located on the saw.

8. A power sprayer according to claim 7, wherein the connector is a brass GHT fitting.

9. A method of reducing the quantity of particulate matter released into the air by operation of a saw, comprising the steps of:
(a) providing a housing on which is mounted a battery connector for receiving a battery, a battery-operated motor operatively connected to the battery connector, a motor-operated liquid pump operatively connected to the motor, a tank for holding a supply of liquid and operatively connected to the pump, and a liquid outlet from the pump connected to a conduit for conveying liquid under pressure from the pump to a location proximate to a blade of the saw;
(b) filling the tank with liquid;
(c) positioning a distal end of the conduit proximate to the saw blade; and
(d) operating the pump to direct liquid at an intersection of the saw blade and a material being sawn to capture the small particulate matter released by the saw blade and prevent the particulate matter from entering the air during operation of the saw.

10. The method of claim 9, wherein the step of positioning an end of the conduit is accomplished by connecting the end of the conduit to a connector located on the saw.

11. The method of claim 9, further comprising the step of positioning the housing on a user's back by supporting the housing with a pair of shoulder straps.

12. The method of claim 9, further comprising a step of mounting the housing on a trolley for transport.
